(19) United States
(12) Patent Application Publication
(10) Pub. No.: US 2026/0157337 A1
(43) Pub. Date: Jun. 11, 2026

(54) QUICK-ASSEMBLY STRUCTURE AND CAT LITTER BOX

(71) Applicant: SHENZHEN PETABOO TECHNOLOGY CO., LTD., SHENZHEN (CN)

(72) Inventor: BOCHAO XU, SHENZHEN (CN)

(21) Appl. No.: 19/408,671

(22) Filed: Dec. 4, 2025

(30) Foreign Application Priority Data
Dec. 6, 2024 (CN) 202423019756.9

(51) Int. Cl. A01K 1/01

(52) U.S. Cl. CPC A01K 1/0107

(57) ABSTRACT

A quick-assembly structure and a cat litter box are provided. The quick-assembly structure includes a base and a cat litter bin. Central shafts are disposed on two sides of the cat litter bin, and the base includes upper hole portions and lower hole portions. The lower hole portions are disposed on the base. Each of the upper hole portions is detachably assembled with a corresponding one of the lower hole portions. When each of the upper hole portions is assembled with the corresponding one of the lower hole portions, the upper hole portions are respectively connected to the lower hole portions to form central holes. The central holes are respectively configured to accommodate the central shafts. When each of the upper hole portions is separated from the corresponding one of the lower hole portions, the central shafts are respectively detached from the lower hole portions on the base.

### TECHNICAL FIELD

The present disclosure relates to a field of pet supplies, and in particular to a quick-assembly structure and a cat litter box.

### BACKGROUND

Cat litter boxes are a relatively new product that has emerged in recent years. The cat litter boxes are configured to store cat litter in a cat litter bin thereof for cats to use for urination and defecation. During daily use, the cat litter bin needs to be disassembled for cleaning. However, a conventional mounting structure of the cat litter boxes is quite complex, making disassembly and cleaning inconvenient.

### SUMMARY

To solve defects in the prior art, the present disclosure provides a quick-assembly structure and a cat litter box.

The quick-assembly structure comprises a base and a cat litter bin. Central shafts are disposed on two sides of the cat litter bin, and the base comprises upper hole portions and lower hole portions. The lower hole portions are disposed on the base. Each of the upper hole portions is detachably assembled with a corresponding one of the lower hole portions. When each of the upper hole portions is assembled with the corresponding one of the lower hole portions, the upper hole portions are respectively connected to the lower hole portions to form central holes. The central holes are respectively configured to accommodate the central shafts. When each of the upper hole portions is separated from the corresponding one of the lower hole portions, the central shafts are respectively detached from the lower hole portions on the base.

The quick-assembly structure further comprises upper covers disposed on the base and lower seats disposed on the base. The upper hole portions are respectively disposed on the upper covers. The lower hole portions are respectively disposed on the lower seats. First fastening portions are disposed on an upper portion of each of the upper covers. Second fastening portions are disposed on an upper side of each of the lower seats. A lower portion of each of the upper covers is rotatably connected to a lower portion of a corresponding one of the lower seats. When the upper covers are rotated to enable the first fastening portions being fastened to the second fastening portions, the upper hole portions and the lower hole portions are assembled together.

The first fastening portions are snapping fasteners, and the second fastening portions are snapping slots.

First rotating portions are disposed on the lower portion of each of the upper covers. Second rotating portions are disposed on the lower portion of each of the lower seats. The first rotating portions are respectively connected to the second rotating portions, so that the lower portion of each of the upper covers is rotatably connected to the lower portion of the corresponding one of the lower seats.

The quick-assembly structure further comprises rotating shafts. Each of the upper covers comprises through grooves, and first shaft holes are defined on two sides of each of the through grooves to form each of the first rotating portions. Connecting arms are disposed on each of the lower seats, and each of the connecting arms defines a second shaft hole to form each of the second rotating portions. When each of the connecting arms is placed in a corresponding one of the through grooves, each of the rotating shafts is placed in the first shaft holes of a corresponding one of the through grooves and the second shaft hole of a corresponding one of the connecting arms, so that each of the first rotating portions is connected to a corresponding one of the second rotating portions.

First positioning portions are disposed on the base. Second positioning portions are disposed on the lower seats. When the lower seats are disposed on the base, the second positioning portions are respectively connected to the first positioning portions.
spacing portions are defined on an inner wall of each of the upper hole portions and an inner wall of each of the lower hole portions. The spacing portions are configured to reduce a friction of each of the central shafts, a corresponding one of the upper hole portions and a corresponding one of the lower hole portions.

A driving mechanism is disposed inside the base. An output end of the driving mechanism is a first gear. A second gear is disposed on one of the central shafts. The second gear is engaged with the first gear.

Support feet are extended from two sides of the base. The support feet are respectively configured to support the central shafts. Each of the lower hole portions is disposed on a top portion of a corresponding one of the support feet.

The present disclosure further provides a cat litter box. The cat litter box comprises the quick-assembly structure described above.

With the above-described structure, during use, the central shafts of the cat litter bin are respectively placed into the central holes of the base, so that the cat litter bin is rotatable on the base. A structure of the quick-assembly structure is simple and easy to use. Furthermore, each of the central holes is formed by assembling each of the upper hole portions and the corresponding one of the lower hole portions together. Each of the upper hole portions is detachably connected to the corresponding one of the lower hole portions. When each of the upper hole portions is separated from the corresponding one of the lower hole portions, each of the central shafts is removed from a corresponding one of the lower hole portions on the base. That is, the cat litter bin is removable from the base for easy disassembly and cleaning. The structure of the quick-assembly structure is simple and an operation thereof is convenient.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

The present disclosure is further described below with reference to the accompanying drawings and embodiments.

FIG. 1 is a schematic diagram of a quick-assembly structure according to one embodiment of the present disclosure.

FIG. 2 is an exploded schematic diagram of the quick-assembly structure according to one embodiment of the present disclosure, where a cat litter bin is separated from a base.

FIG. 3 is another exploded schematic diagram of the quick-assembly structure according to one embodiment of the present disclosure, where the cat litter bin is separated from the base.

FIG. 4 is a schematic diagram of the quick-assembly structure according to one embodiment of the present disclosure, where upper covers are rotated in an open state.

FIG. 5 is an exploded schematic diagram of the quick-assembly structure shown in FIG. 4.

FIG. 6 is an enlarged schematic diagram of portion A of the quick-assembly structure shown in FIG. 2.

FIG. 7 is a schematic diagram of one of the upper covers according to one embodiment of the present disclosure.

FIG. 8 is a schematic diagram of one of lower seats according to one embodiment of the present disclosure.

FIG. 9 is an exploded schematic diagram of the one of the lower seats according to one embodiment of the present disclosure.

### DETAILED DESCRIPTION

### Embodiment 1

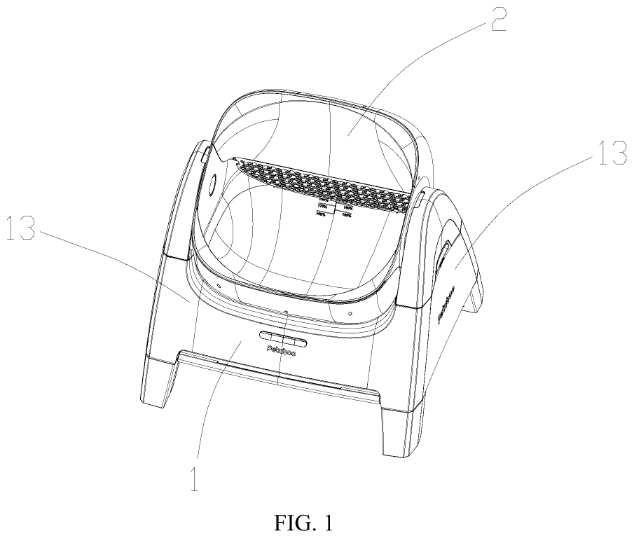

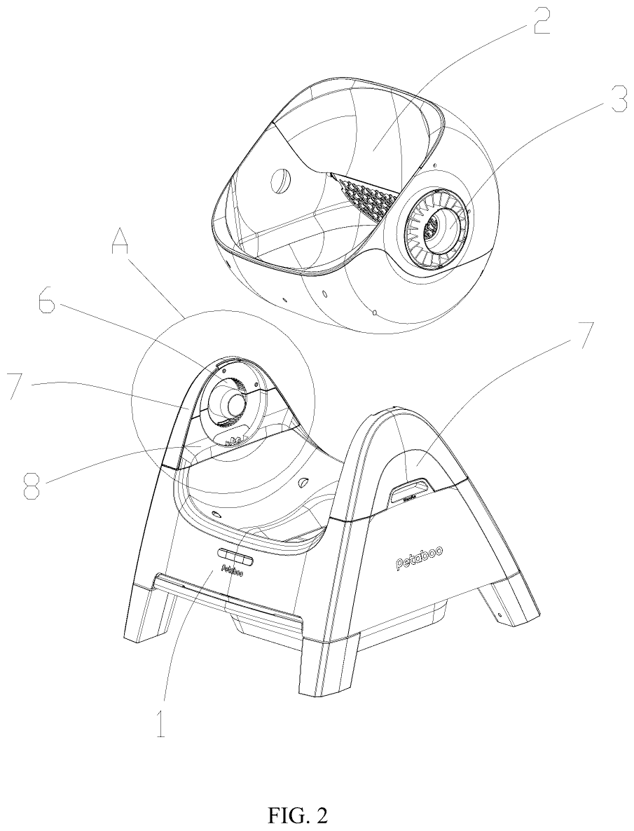

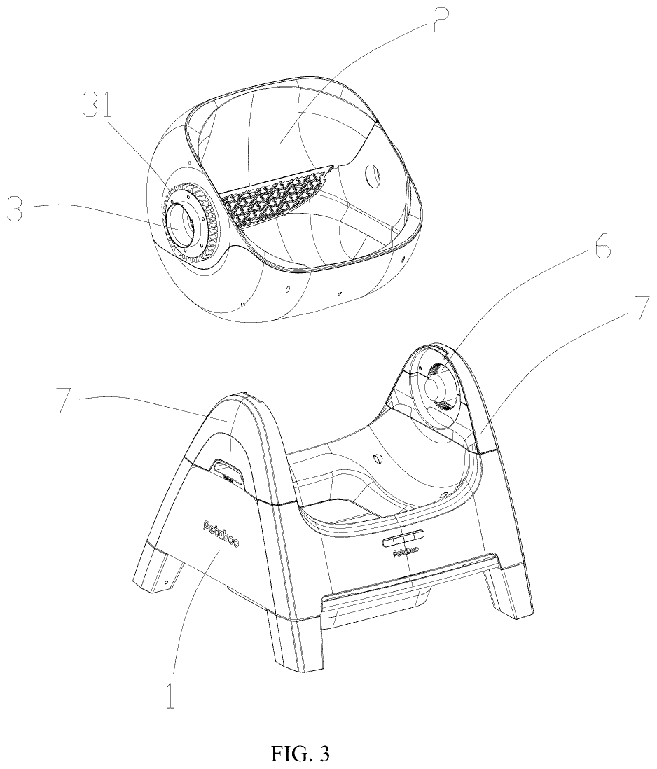

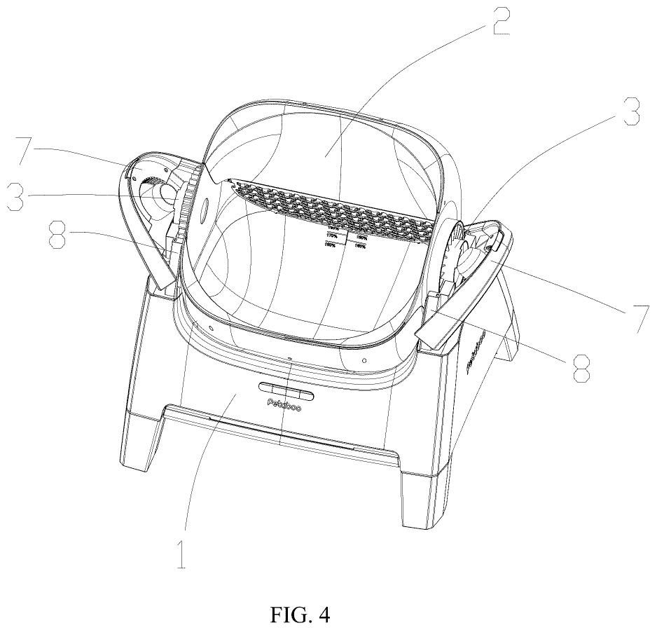

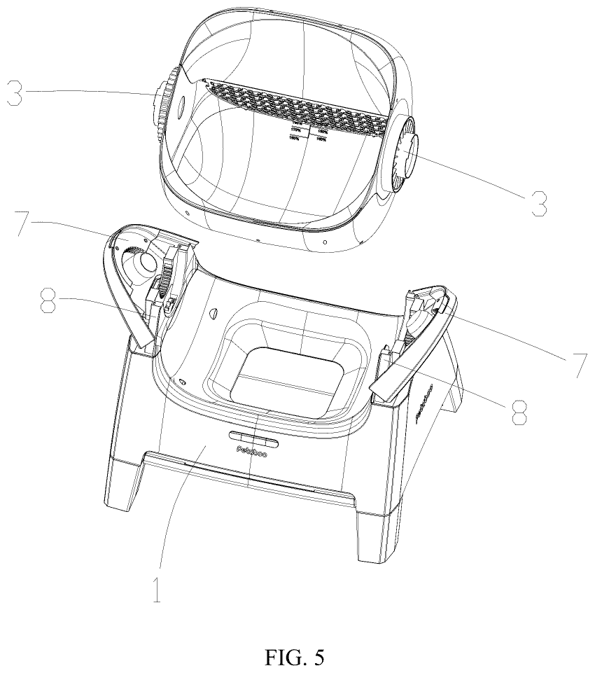

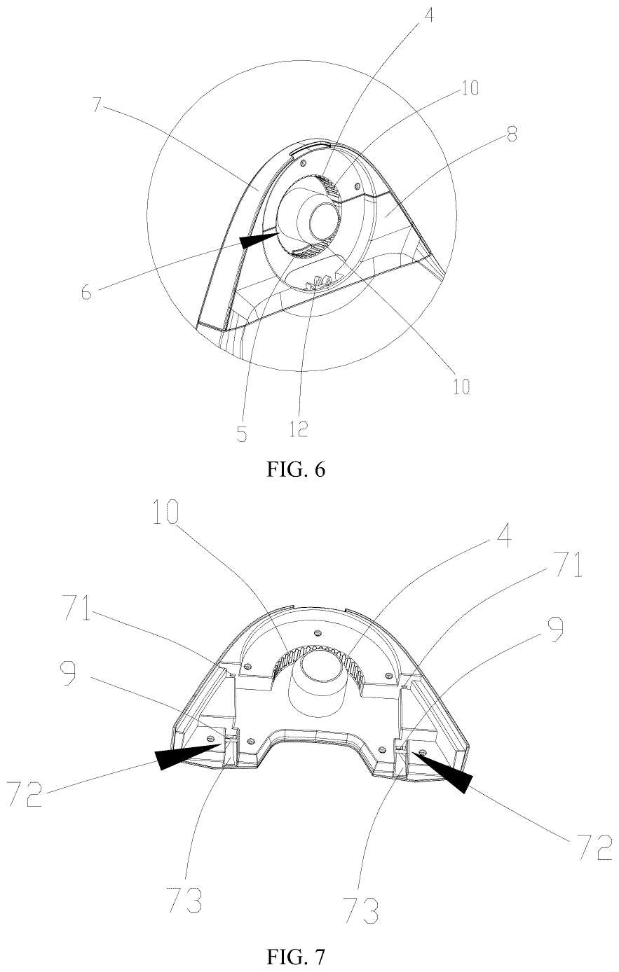

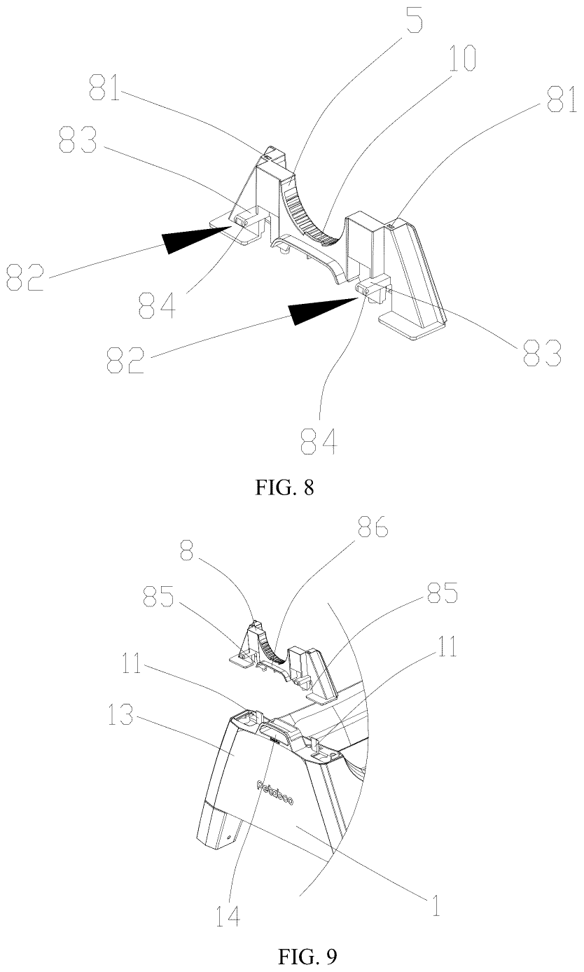

As shown in FIGS. 1-9, the present disclosure provides a quick-assembly structure. The quick-assembly structure comprises a base and a cat litter bin 2. Central shafts 3 are disposed on two sides of the cat litter bin 2, and the base 1 comprises upper hole portions 4 and lower hole portions 5. The lower hole portions 5 are disposed on the base 1. Each of the upper hole portions 4s is detachably assembled with a corresponding one of the lower hole portions 5. When each of the upper hole portions 4 is assembled with the corresponding one of the lower hole portions 5, the upper hole portions 4 are respectively connected to the lower hole portions 5 to form central holes 6. The central holes 6 are respectively configured to accommodate the central shafts 3. When each of the upper hole portions 4 is separated from the corresponding one of the lower hole portions 5, the central shafts 3 are respectively detached from the lower hole portions 5 on the base 1.

With above-described structure, during use, the central shafts 3 of the cat litter bin 2 are respectively placed into the central holes 6 of the base 1, so that the cat litter bin 2 is rotatable on the base 1. A structure of the quick-assembly structure is simple and easy to use. Furthermore, each of the central holes 6 is formed by assembling each of the upper hole portions 4 and the corresponding one of the lower hole portions 5 together. Each of the upper hole portions 4 is detachably connected to the corresponding one of the lower hole portions 5. When each of the upper hole portions 4 is separated from the corresponding one of the lower hole portions 5, each of the central shafts 3 is removed from a corresponding one of the lower hole portions 5 on the base 1. That is, the cat litter bin 2 is removable from the base 1 for easy disassembly and cleaning. The structure of the quick-assembly structure is simple and an operation thereof is convenient.

Each of the upper hole portions is a first semi-circular hole. Correspondingly, each of the lower hole portions is a second semi-circular hole. Each of the upper hole portions 4 is assembled with the corresponding one of the lower hole portions 5 to form a corresponding one of the central holes that is a circular hole.

In the embodiment, the quick-assembly structure further comprises upper covers 7 disposed on the base 1 and lower seats 8 disposed on the base 1. The upper hole portions 4 are respectively disposed on the upper covers 7. The lower hole portions 5 are respectively disposed on the lower seats 8. First fastening portions 71 are disposed on an upper portion of each of the upper covers 7. Second fastening portions 81 are disposed on an upper side of each of the lower seats 8. A lower portion of each of the upper covers 7 is rotatably connected to a lower portion of a corresponding one of the lower seats 8. When the upper covers 7 are rotated to enable the first fastening portions 71 being fastened to the second fastening portions 81, the upper hole portions 4 and the lower hole portions 5 are assembled together.

By connecting the first fastening portions respectively to the second fastening portions, the upper covers are respectively fastened to the lower seats. That is, each of the upper hole portions and the corresponding one of the lower hole portions are assembled together to form the corresponding one of the central holes. In addition, by separating the first fastening portions from the second fastening portions, each of the upper covers is rotatable on the corresponding one of the lower seats, and each of the upper hole portions is allowed to be separated from the corresponding one of the lower hole portions, so that the central shafts of the cat litter bin are allowed to be detached from the lower hole portions on the base, thereby achieving a disassembly of the cat litter bin. In summary, by the above structural configurations, the cat litter bin is able to be quickly disassembled and assembled relative to the base 1.

The first fastening portions 71 are snapping fasteners, and the second fastening portions 81 are snapping slots, which are simple in structure and convenient to disassemble and assemble. Furthermore, there are two snapping fasteners and two snapping slots.

In the embodiment, first rotating portions 72 are disposed on the lower portion of each of the upper covers 7. Second rotating portions 82 are disposed on the lower portion of each of the lower seats 8. The first rotating portions 72 are respectively connected to the second rotating portions 82, so that the lower portion of each of the upper covers 7 is rotatably connected to the lower portion of the corresponding one of the lower seats 8. The first rotating portions 72 and the second rotating portions 82 have simple structures and are convenient to disassemble and assemble.

Specifically, the quick-assembly structure further comprises rotating shafts 9. Each of the upper covers 7 comprises through grooves 73, and first shaft holes (not shown in the figures) are defined on two sides of each of the through grooves 73 to form each of the first rotating portions 72. Connecting arms 83 are disposed on each of the lower seats 8, and each of the connecting arms 83 defines a second shaft hole 84 to form each of the second rotating portions 82. When each of the connecting arms 83 is placed in a corresponding one of the through grooves 73, each of the rotating shafts 9 is placed in the first shaft holes of a corresponding one of the through grooves 73 and the second shaft hole 84 of a corresponding one of the connecting arms 83, so that each of the first rotating portions 72 is connected to a corresponding one of the second rotating portions. Such configurations are simple in structure and are convenient to disassemble and assemble.

Furthermore, first positioning portions 11 are disposed on the base 1. Second positioning portions 85 are disposed on the lower seats 8. When the lower seats 8 are disposed on the base 1, the second positioning portions 85 are respectively connected to the first positioning portions 11. Specifically, the first positioning portions 11 and the second positioning portions 85 are respectively positioning blocks and positioning grooves. The lower seats are fixed on the base through screws.

In the embodiment, spacing portions 10 are defined on an inner wall of each of the upper hole portions 4 and an inner wall of each of the lower hole portions 5. The spacing portions 10 are configured to reduce a friction of each of the central shafts 3, a corresponding one of the upper hole portions 4 and a corresponding one of the lower hole portions 5. Specifically, the spacing portions are recesses on the inner wall of each of the upper hole portions 4 and the inner wall of each of the lower hole portions 5, so as to reduce a contact area and reduce the friction of each of the central shafts 3, the corresponding one of the upper hole portions 4 and the corresponding one of the lower hole portions 5.

In the embodiment, a driving mechanism (not shown in the figures) is disposed on the base 1. An output end of the driving mechanism is a first gear 12, and a second gear 31 is disposed on one of the central shafts 3. The second gear 31 is engaged with the first gear 12. By providing the driving mechanism, the driving mechanism drives the first gear to rotates, so as to drive the second gear to rotate, thereby driving the cat litter bin to rotate. The first gear and the second gear are simple in structure and are convenient to disassemble and assemble.

In the embodiment, support feet 13 are extended from two sides of the base 1. The support feet 13 are respectively configured to support the central shafts 3. Each of the lower hole portions 5 is disposed on a top portion of a corresponding one of the support feet 13. Furthermore, each of the lower seats is disposed at the top portion of the corresponding one of the support feet 13, which has a simple structure and a reasonable design. In addition, each of the support feet comprises a first handle 14 for carrying the cat litter bin, which is more convenient to use. Correspondingly, each of the lower seats comprises a second handle 86. Each second handle 86 is correspondingly to a position of a corresponding first handle 14. During a process of moving a cat litter box, each second handle bears a force of the corresponding first handle 14, ensuring that the quick-assembly structure of the cat litter box is stable and reliable.

### Embodiment 2

The present disclosure further provides a cat litter box. The cat litter box comprises the quick-assembly structure described above. Because the cat litter box in the embodiment comprises the quick-assembly structure for the cat litter bin, the cat litter box possesses all features of the quick-assembly structure.

With the above-described structure, during use, the central shafts 3 of the cat litter bin 2 are respectively placed into the central holes 6 of the base 1, so that the cat litter bin 2 is rotatable on the base 1. The structure of the quick-assembly structure is simple and easy to use. Furthermore, each of the central holes 6 is formed by assembling each of the upper hole portions 4 and the corresponding one of the lower hole portions 5 together. Each of the upper hole portions 4 is detachably connected to the corresponding one of the lower hole portions 5. When each of the upper hole portions 4 is separated from the corresponding one of the lower hole portions 5, each of the central shafts 3 is removed from a corresponding one of the lower hole portions 5 on the base 1. That is, the cat litter bin 2 is removable from the base 1 for easy disassembly and cleaning. The structure of the quick-assembly structure is simple and an operation thereof is convenient.

The above content is a further detailed description of the present disclosure in combination with specific optional implementation methods, and it cannot be determined that the specific implementation of the present disclosure is limited to these descriptions. For those skilled in the art, several simple deductions or substitutions can be made without departing from the concept of the present disclosure, which should be regarded as falling within the protection scope of the present disclosure.

What is claimed is:

1. A quick-assembly structure, comprising:
a base; and
a cat litter bin;
wherein central shafts are disposed on two sides of the cat litter bin, and the base comprises upper hole portions and lower hole portions;
wherein the lower hole portions are disposed on the base, each of the upper hole portions is detachably assembled with a corresponding one of the lower hole portions, and when each of the upper hole portions is assembled with the corresponding one of the lower hole portions, the upper hole portions are respectively connected to the lower hole portions to form central holes;
wherein the central holes are respectively configured to accommodate the central shafts, and when each of the upper hole portions is separated from the corresponding one of the lower hole portions, the central shafts are respectively detached from the lower hole portions on the base.

2. The quick-assembly structure according to claim 1, wherein the quick-assembly structure further comprises upper covers disposed on the base and lower seats disposed on the base;
wherein the upper hole portions are respectively disposed on the upper covers, the lower hole portions are respectively disposed on the lower seats, first fastening portions are disposed on an upper portion of each of the upper covers, second fastening portions are disposed on an upper side of each of the lower seats, and a lower portion of each of the upper covers is rotatably connected to a lower portion of a corresponding one of the lower seats;
wherein when the upper covers are rotated to enable the first fastening portions being fastened to the second fastening portions, the upper hole portions and the lower hole portions are assembled together.

3. The quick-assembly structure according to claim 2, wherein the first fastening portions are snapping fasteners, and the second fastening portions are snapping slots.

4. The quick-assembly structure according to claim 2, wherein first rotating portions are disposed on the lower portion of each of the upper covers, second rotating portions are disposed on the lower portion of each of the lower seats, and the first rotating portions are respectively connected to the second rotating portions, so that the lower portion of each of the upper covers is rotatably connected to the lower portion of the corresponding one of the lower seats.

5. The quick-assembly structure according to claim 4, wherein the quick-assembly structure further comprises rotating shafts, each of the upper covers comprises through grooves, and first shaft holes are defined on two sides of each of the through grooves to form each of the first rotating portions;
wherein connecting arms are disposed on each of the lower seats, and each of the connecting arms defines a second shaft hole to form each of the second rotating portions;
wherein when each of the connecting arms is placed in a corresponding one of the through grooves, each of the rotating shafts is placed in the first shaft holes of a corresponding one of the through grooves and the second shaft hole of a corresponding one of the connecting arms, so that each of the first rotating portions is connected to a corresponding one of the second rotating portions.

6. The quick-assembly structure according to claim 2, wherein first positioning portions are disposed on the base, second positioning portions are disposed on the lower seats, and when the lower seats are disposed on the base, the second positioning portions are respectively connected to the first positioning portions.

7. The quick-assembly structure according to claim 1, wherein spacing portions are defined on an inner wall of each of the upper hole portions and an inner wall of each of the lower hole portions, and the spacing portions are configured to reduce a friction between each of the central shafts, a corresponding one of the upper hole portions and a corresponding one of the lower hole portions.

8. The quick-assembly structure according to claim 1, wherein a driving mechanism is disposed inside the base, an output end of the driving mechanism is a first gear, a second gear is disposed on one of the central shafts, and the second gear is engaged with the first gear.

9. The quick-assembly structure according to claim 1, wherein support feet are extended from two sides of the base, the support feet are respectively configured to support the central shafts, each of the lower hole portions is disposed on a top portion of a corresponding one of the support feet.

10. A cat litter box, comprising: the quick-assembly structure according to claim 1.
